(19) United States
(12) Patent Application Publication
(10) Pub. No.: US 2013/0293485 A1
(43) Pub. Date: Nov. 7, 2013

(54) TOUCH PANEL AND METHOD OF MANUFACTURING THE SAME

(71) Applicant: SAMSUNG ELECTRO-MECHANICS CO., LTD., Gyunggi-do (KR)

(72) Inventors: Tae Hoon Kim, Gyunggi-do (KR); Jin Mun Ryu, Gyunggi-do (KR); Ha Yoon Song, Gyunggi-do (KR); Ho Joon Park, Gyunggi-do (KR)

(73) Assignee: SAMSUNG ELECTRO-MECHANICS CO., LTD., Gyunggi-do (KR)

(21) Appl. No.: 13/661,344

(22) Filed: Oct. 26, 2012

(30) Foreign Application Priority Data
May 7, 2012 (KR) 10-2012-0048132

(51) Int. Cl. G06F 3/041; H01H 11/00

(52) U.S. Cl. 345/173; 29/622; 178/18.03

(57) ABSTRACT

Disclosed herein is a method of manufacturing a touch panel, the method including: (A) supplying a raw glass plate; (B) forming an electrode layer on each of a plurality of a glass substrate unit areas on the raw glass plate; (C) forming a protection layer to cover the electrode layer on the glass substrate unit areas; (D) cutting the raw glass plate into the glass substrate units; and (E) tempering the cut glass substrate units.

### CROSS REFERENCE TO RELATED APPLICATION

This application claims the benefit of Korean Patent Application No. 10-2012-0048132, filed on May 7, 2012, entitled “Touch Panel and Method for Manufacturing the Same”, which is hereby incorporated by reference in its entirety into this application.

### BACKGROUND OF THE INVENTION

1. Technical Field

The present invention relates to a touch panel and a method of manufacturing the same.

2. Description of the Related Art

As computers that use digital technology are developed, auxiliary devices of the computers are also being developed, and personal computers, portable transmitting devices, and other personal data processing apparatuses process texts and graphics using various input devices such as a keyboard, a mouse, or the like.

However, according to the rapid progress of an information society, uses of computers are gradually extended, and thus it is difficult to operate products efficiently just using a keyboard and a mouse, which currently function as an input device. Thus, a device that anybody can use to input information easily and which is simple and has little malfunctions, is increasingly required.

In addition, a focus of technology related to input devices is moved from the general inputting function to high reliability, durability, innovation, and processing technology, and a touch panel through which data such as text and graphics may be input is developed as such an inputting device to achieve these functions.

A touch panel is installed on a display surface of an image display device such as a flat panel display device such as an electronic organizer, a liquid crystal display device (LCD), a plasma display panel (PDP), an electroluminescence (EL) device, etc. or a cathode ray tube (CRT), and a user is able to select data by viewing the image display device.

Examples of the touch panel include resistive type touch panels, capacitive type touch panels, electro-magnetic type touch panels, surface acoustic wave (SAW) type touch panels, and infrared type touch panels. These touch panels of various types are applied to electronic appliances in consideration of signal amplification, a resolution difference, difficulty in design and processing technology, optical characteristics, electrical characteristics, mechanical characteristics, resistance to environments, inputting characteristic, durability, and economy, and among these, the resistive type touch panels and the capacitive type touch panels are currently used in the widest range.

Meanwhile, touch panels that are currently manufactured include an electrode layer that is directly formed on a window in order to obtain a thin touch panel structure.

Here, the window is typically formed of a tempered glass substrate. A method of manufacturing a touch panel that is manufactured by tempering a glass substrate is disclosed in, for example, in Korean Patent Laid-Open Publication No. 2010-0084257 under the title of “Touch Screen Panel and Method of Manufacturing the Same.”

The method of manufacturing the touch screen panel includes tempering a raw glass plate, forming an electrode layer on a glass substrate unit area on the tempered raw glass plate, and cutting the glass substrate unit from the raw glass plate.

However, according to the above patent publication, only surfaces of the glass substrate except “edge surfaces” of the glass substrate are tempered, and the edge surfaces of the glass substrate, that is, left and right surfaces of the glass substrate are not tempered. Accordingly, in a touch panel that is manufactured according to the method of manufacturing the touch screen panel, the glass substrate is weak in durability.

To solve the above problem, there is another method of manufacturing a touch panel according to the conventional art, in which a raw glass plate is cut in advance into glass substrate units, and the cut glass substrate units are tempered, and an electrode layer is formed on each of the tempered glass substrate units. However, according to the method of manufacturing a touch panel as above, the electrode layer is formed on each of the glass substrate units in separate operations, and thus mass production of the touch panel is not possible.

### SUMMARY OF THE INVENTION

The present invention has been made in an effort to provide a touch panel including a glass substrate where even left and right sides of the glass substrate are tempered.

The present invention has been also made in an effort to provide a method of manufacturing a touch panel, in which an electrode layer is formed on each of a plurality of glass substrate unit areas on a raw glass plate in a single operation to improve mass production of the touch panel, and then a glass substrate is cut into glass substrates units and the glass substrate is tempered so that up to left and right sides of a glass substrate are tempered.

According to a first preferred embodiment of the present invention, there is provided a touch panel including: a glass substrate; an electrode layer formed on the glass substrate; and a protection layer formed on the glass substrate to cover the electrode layer.

A tempered layer may be formed on surfaces of the glass substrate except a surface where the electrode layer and the protection layer are formed.

The protection layer may be formed of a transparent insulating ceramic material.

The protection layer may be formed of at least one oxide or a composite oxide selected from the group consisting of Al₂O₃, MgO, CaO, SiO₂, TiO₂, BaO, ZrO₂, and CeO₂.

According to a second preferred embodiment of the present invention, there is provided a method of manufacturing a touch panel, the method including: (A) supplying a raw glass plate; (B) forming an electrode layer on each of a plurality of glass substrate unit areas on the raw glass plate; (C) forming a protection layer to cover the electrode layer on the glass substrate unit areas; (D) cutting the raw glass substrate into the glass substrate units; and (E) tempering the cut glass substrate units.

The method may further include, after operation (A), tempering the raw glass plate.

In the tempering of the raw glass plate, the raw glass plate may be dipped in a KNO₃ solution and be heated at a temperature of 400 to 420° C. for five to seven hours.

In operation (E), the glass substrate units may be dipped in a KNO₃ solution and be heated at a temperature of 400 to 420° C. for five to seven hours.

The protection layer may be formed of a transparent insulating ceramic material.

The protection layer may be formed of at least one oxide or a composite oxide selected from the group consisting of Al₂O₃, MgO, CaO, SiO₂, TiO₂, BaO, ZrO₂, and CeO₂.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view of a touch panel according to an embodiment of the present invention;

FIG. 2 is a flowchart illustrating a method of manufacturing a touch panel according to an embodiment of the present invention;

FIG. 3 is a plan view of a raw glass plate, showing an operation of forming an electrode layer included in the method of FIG. 2;

FIG. 4 is a plan view of a raw glass plate showing an operation of a forming a protection layer included in the method of FIG. 2;

FIG. 5 is a plan view illustrating a glass substrate showing an operation of cutting a glass substrate unit area included in the method of FIG. 2; and

FIG. 6 is a cross-sectional view illustrating the glass substrate illustrated in FIG. 5.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

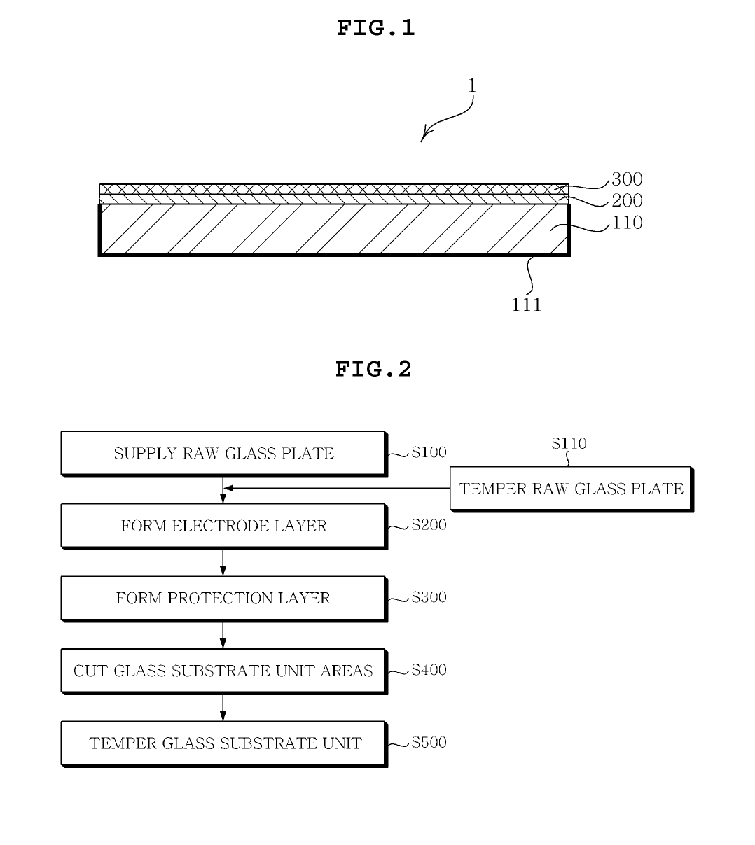

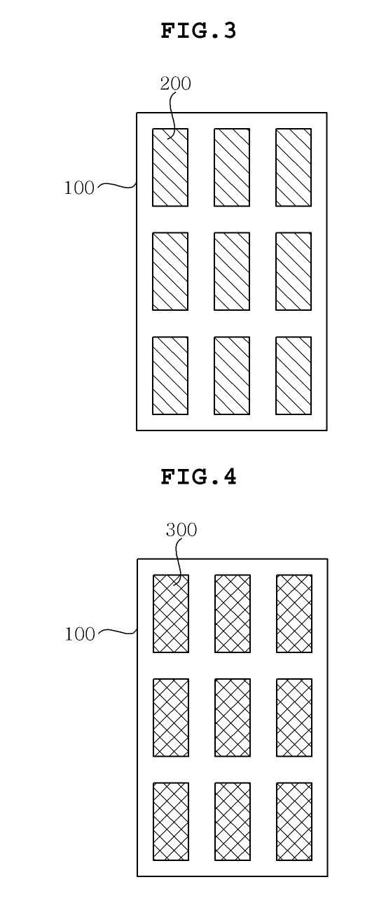

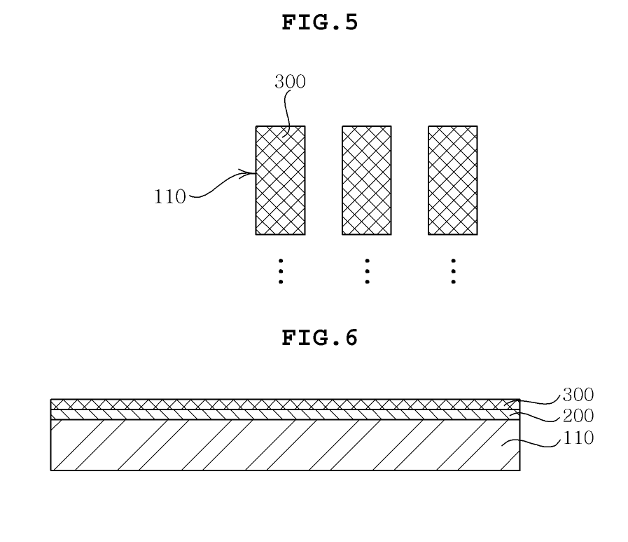

FIG. 1 is a cross-sectional view of a touch panel 1 according to an embodiment of the present invention. FIG. 2 is a flowchart illustrating a method of manufacturing a touch panel according to an embodiment of the present invention. FIG. 3 is a plan view of a raw glass plate, showing an operation of forming an electrode layer included in the method of FIG. 2. FIG. 4 is a plan view of a raw glass plate showing an operation of a forming a protection layer included in the method of FIG. 2. FIG. 5 is a plan view illustrating a glass substrate showing an operation of cutting a glass substrate unit area included in the method of FIG. 2. FIG. 6 is a cross-sectional view illustrating the glass substrate illustrated in FIG. 5.

As illustrated in FIG. 1, the touch panel 1 according to an embodiment of the present invention includes a glass substrate 110, an electrode layer 200 formed on the glass substrate 110, and a protection layer 300 formed on the glass substrate 110 to cover the electrode layer 200.

The glass substrate 110 provides an area where the electrode layer 200 which will be described later is to be formed. The glass substrate 110 may be a window included on an outermost portion of the touch panel 1. When a window is used as the glass substrate, the touch panel 1 according to the current embodiment of the present invention includes the electrode layer 200 that is directly formed on the window, and thus an operation of attaching an additional transparent substrate on the window may be omitted, thereby simplifying the manufacturing process and reducing the overall thickness of the touch panel 1.

The electrode layer 200 generates a touch signal so that a user may recognize touch coordinates on a controller (not shown) when the user touches the glass substrate 110.

The electrode layer 200 may include an electrode formed of a metal. The metal electrode may include one selected from the group consisting of copper (Cu), aluminum (Al), gold (Au), silver (Ag), titanium (Ti), palladium (Pd), chromium (Cr), and a combination thereof. Alternatively, the metal electrode may be formed of metal silver that is formed by exposing or developing a silver salts emulsion layer. The metal electrode may be formed by patterning the glass substrate 110 into a mesh pattern. Here, the metal electrode may be formed on the glass substrate 110 using, for example, a plating process or an evaporation process using sputtering.

The electrode layer 200 may include an electrode formed of a conductive polymer. Here, the conductive polymer includes poly-3,4-ethylenedioxythiopene/polystyrene sulfonate (PEDOT/PSS), polyaniline, polyacetylene, or polyphenylene vinylene. Alternatively, the electrode layer 200 may include an electrode formed of a metal oxide. The metal oxide may be formed of indium-tin oxide.

The electrode formed of a conductive polymer or the electrode formed of a metal oxide described above may be formed on the glass substrate 110 by using a dry process, a wet process, or a direct patterning process. Here, the dry process may be sputtering, evaporation, etc., the wet process may be dip coating, spin coating, roll coating, spray coating, etc., and the direct patterning process may be screen printing, gravure printing, inkjet printing, etc.

Meanwhile, the electrode included in the electrode layer 200 described above may include a first electrode and a second electrode which allow that a touch position can be identified by X-axis coordinates and Y-axis coordinates. Here, the first electrode and the second electrode may be formed together on a surface of the glass substrate 110.

Alternatively, the first electrode and the second electrode may be respectively formed on a first surface and a second surface of an insulating layer while including the insulating layer (not shown) that is formed on the glass substrate, interposed therebetween. In this case, in addition to the first and second electrodes, the electrode layer 200 further includes the insulating layer formed on the glass substrate 110.

Also, the electrode layer 200 may further include an electrode wiring formed around a border of the above electrodes in order to receive an electrical signal from the above electrodes. Here, in order to simplify the manufacturing method of the touch panel 1 and to reduce a lead time, the electrode wiring may be integrally formed with the above electrodes. In this case, an operation of bonding the electrodes and the electrode wiring may be omitted, and generation of steps between the electrodes and the electrode wiring or poor bonding therebetween may be prevented beforehand.

The protection layer 300 is formed on the glass substrate 110 to cover the electrode layer 200. The protection layer 300 performs the function of preventing scratches on the electrode layer 200 or other damages thereto during the manufacture of the touch panel 1. In particular, while tempering the glass substrate 110, which will be described later, the protection layer 300 protects the electrode layer 200 by preventing the electrode layer 200 from being exposed to a high-temperature environment.

Meanwhile, an image display device may be disposed to correspond to a surface of the glass substrate 110. In this case, in order that a user may recognize an image provided from the image display device, the protection layer 300 needs to be transparent. Also, the protection layer 300 may be formed of a material having excellent heat resistance so that the electrode layer 200 is protected particularly in a high-temperature environment.

As an example of the protection layer 300 having the above-described characteristics, the protection layer 300 may be formed of a ceramic material that is transparent and has insulating characteristics. In detail, the protection layer 300 may be formed of at least one oxide or a composite oxide that is selected from the group consisting of Al₂O₃, MgO, CaO, SiO₂, TiO₂, BaO, ZrO₂, and CeO₂.

In addition, the protection layer 300 may be formed on the glass substrate 110 to cover the electrode layer 200 using various methods such as evaporation.

As the electrode layer 200 is covered by the protection layer 300, it is not exposed to the outside and protected, and thus generation of scratches to the electrode layer 200 or the like may be prevented in advance during the manufacture of the touch panel 1. Also, as the protection layer 300 is formed of the above-described material having a high melting point, even when the glass substrate 110 is undergone a glass tempering operation, which will be described later, the electrode layer 200 is protected by the protection layer 300 and is not damaged.

Meanwhile, a tempered layer 111 is formed on surfaces of the above-described glass substrate 110 except a surface where the electrode layer 200 and the protection layer 300 are formed. That is, referring to FIG. 1, the tempered layer 111 is formed on a lower surface, left and right surfaces, and front and back surfaces of the glass substrate 110 except an upper surface of the glass substrate 110.

The tempered layer 111 is formed by tempering the glass substrate 110. The glass substrate 110 is tempered by dipping the glass substrate 110 in a tempering vessel (not shown) containing a KNO₃ solution, and by heating the glass substrate 110 at a temperature of 400 to 420° C. for about five to seven hours. However, the temperature and period of time set for the glass tempering operation are not limited thereto. The glass may be tempered in various conditions where a tempered layer may be formed. While the glass substrate 110 is tempered, sodium (Na) existing on a surface of the glass substrate 110 is displaced by potassium (K) to form the tempered layer 111 on the surfaces of the glass substrate 110. As the tempered layer 111 is formed on the surfaces of the glass substrate 110, strength of the glass substrate 110 is improved.

Here, the protection layer 300 formed on a surface of the glass substrate 110 is formed of the above-described material having a high melting point, and thus even when the protection layer 300 is contained in the tempering vessel at the high temperature, the protection layer 300 will not deform but maintain its form. The electrode layer 200 covered by the protection layer 300 is not exposed due to the protection layer 300 but is protected thereby.

When the protection layer 300 covering the electrode layer 200 is formed and the glass substrate 110 is tempered, as described above, the tempered layer 111 is formed on surfaces of the glass substrate 110 except for the surface on which the electrode layer 200 and the protection layer 300 are formed.

Referring to FIG. 1, the touch panel 1 according to the current embodiment includes the tempered layer 111 on a lower surface and front and back surfaces of the glass substrate 110, and particularly on left and right surfaces of the glass substrate 110. Accordingly, compared to a conventional touch panel structure where the tempered layer 111 may not be formed on the left and right surfaces of the glass substrate 110, in the touch panel 1, strength of the glass substrate 110 is further improved.

The method of manufacturing a touch panel according to an embodiment of the present invention may include, as illustrated in FIG. 2, (A) supplying a raw glass plate (S100); (B) forming an electrode layer on a glass substrate unit area on the raw glass plate (S200); (C) forming a protection layer to cover the electrode layer on the glass substrate unit area (S300); (D) cutting the raw glass plate into the glass substrate units (S400); and (E) tempering the cut glass substrate unit (S500).

In operation (A) S100, a raw glass plate 100 is supplied. The raw glass plate 100 has a predetermined surface area where at least one glass substrate unit area may be formed.

Operation (B) S200, which will be described later, may be performed without tempering the raw glass plate 100, or to perform an operation of tempering a glass twice, operation S110 in which the raw glass plate 100 itself is first tempered may also be performed before operation (B) S200.

Operation 5110 of tempering the raw glass plate 100 may be performed by dipping the raw glass plate 100 in a tempering vessel (not shown) containing a KNO₃ solution, and by heating the same at a temperature of 400 to 420° C. for about five to seven hours. However, the temperature and period of time set for the glass tempering operation are not limited thereto. The glass may be tempered in various conditions where a tempered layer may be formed.

In operation (B) S200, as illustrated in FIG. 3, the electrode layer 200 is formed in each of the glass substrate unit areas on the raw glass plate 100. Here, a glass substrate unit area refers to an area where the glass substrate 110 (see FIG. 1) which is to be included in a touch panel structure is to be formed when performing operation (D) S400, which will be described below.

According to the method of manufacturing a touch panel of the current embodiment of the present invention, operation (B) S200, in which the electrode layer 200 is formed on at least one glass substrate unit area on the raw glass substrate 100 using a single operation, mass production of the touch panel 1 is further possible compared to a method of manufacturing a conventional touch panel, in which the electrode layer 200 has to be formed separately for each of glass substrate units 110 after cutting the raw glass plate 100 into the glass substrate units 110 (see FIG. 5).

The material or the method of forming the electrode layer 200 has been described in detail above with reference to the touch panel 1 according to the embodiment of the present invention, and thus here the detailed description thereof will be omitted.

In operation (C) S300, as illustrated in FIG. 4, the protection layer 300 is formed to cover the electrode layer 200 on glass substrate unit areas of the raw glass plate 100. Like the operation of forming the electrode layer 200 described above, when forming the protection layer 300, instead of forming the protection layer 300 in different operations of the glass substrate unit areas 110, the protection layer 300 is formed on at least one glass substrate unit area on the raw glass plate 100 in a single operation.

The material and the method of forming the protection layer 300 have been described in detail with reference to the touch panel 1, and thus detailed description thereof will be omitted.

In operation (D) S400, as illustrated in FIG. 5, the raw glass plate 100 is cut into glass substrate units. The cut glass substrate units 110 may be the glass substrate 110 that is included in a touch panel structure. The glass substrate units 110 may be a window that is included in an outermost portion of the touch panel structure.

After performing operation (D) S400, as illustrated in FIG. 6, the electrode layer 200 is formed on a surface of the glass substrate units 110, and the protection layer 300 is formed on the surface of the glass substrate units 110 to cover the electrode layer 200, and thus the glass substrates 110 has a stacked structure.

In operation (E) S500, the cut glass substrate units 110 are tempered. The tempering of glass of the glass substrate units 110 may be performed, as the glass tempering operation which has been described above, by dipping the glass substrate units 110 in a tempering vessel (not shown) containing a KNO₃ solution, and by heating the same at a temperature of 400 to 420° C. for about five to seven hours. However, the temperature and period of time set for the glass tempering operation are not limited thereto. The glass may be tempered in various conditions where a tempered layer may be formed.

According to the method of manufacturing the touch panel 1 of the embodiments of the present invention, while operation (E) is performed, the electrode layer 200 is protected by using the protection layer 300 and is not damaged. In addition, in regard to the glass substrate units 110, as illustrated in FIG. 1, the tempered layer 111 is formed on all of the surfaces of the glass substrate units 110 except a surface thereof where the electrode layer 200 and the protection layer 300 are formed. In particular, as the tempered layer 111 is formed on the left and right surfaces of the glass substrate units 110, strength of the glass substrate units 110 is further improved.

According to the embodiments of the present invention, a glass substrate constituting a touch panel is formed of a tempered glass so that strength of the glass substrate may be provided. In particular, according to the embodiments of the present invention, as a tempered layer is formed also on left and right surfaces of the glass substrate, the strength of the glass substrate may be further improved.

In addition, according to the embodiments of the present invention, a protection layer covering an electrode layer is formed, and thus the electrode layer may be protected during the manufacture of the touch panel from being damaged. In particular, when tempering the glass substrate on which the electrode layer is formed, even when the glass substrate is dipped in a tempering vessel at a high temperature, the electrode layer may be protected by using a protection layer having a high heat resistance.

Also, according to the advantages of the present invention, an electrode layer is formed on a plurality of glass substrate unit areas on a raw glass plate in a single operation, and thus mass production of the touch panel is improved.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A touch panel comprising:
a glass substrate;
an electrode layer formed on the glass substrate; and
a protection layer formed on the glass substrate to cover the electrode layer.

2. The touch panel as set forth in claim 1, wherein a tempered layer is formed on surfaces of the glass substrate except a surface where the electrode layer and the protection layer are formed.

3. The touch panel as set forth in claim 1, wherein the protection layer is formed of a transparent insulating ceramic material.

4. The touch panel as set forth in claim 1, wherein the protection layer is formed of at least one oxide or a composite oxide selected from the group consisting of Al₂O₃, MgO, CaO, SiO₂, TiO₂, BaO, ZrO₂, and CeO₂.

5. A method of manufacturing a touch panel, the method comprising:
(A) supplying a raw glass plate;
(B) forming an electrode layer on each of a plurality of glass substrate unit areas on the raw glass plate;
(C) forming a protection layer to cover the electrode layer on the glass substrate unit areas;
(D) cutting the raw glass substrate into the glass substrate units; and
(E) tempering the cut glass substrate units.

6. The method as set forth in claim 5, further comprising, after operation (A), tempering the raw glass plate.

7. The method as set forth in claim 6, wherein in the tempering of the raw glass plate, the raw glass plate is dipped in a KNO₃ solution and is heated at a temperature of 400 to 420° C. for five to seven hours.

8. The method as set forth in claim 5, wherein in operation (E), the glass substrate units are dipped in a KNO₃ solution and are heated at a temperature of 400 to 420° C. for five to seven hours.

9. The method as set forth in claim 5, wherein the protection layer is formed of a transparent insulating ceramic material.

10. The method as set forth in claim 5, wherein the protection layer is formed of at least one oxide or a composite oxide selected from the group consisting of Al₂O₃, MgO, CaO, SiO₂, TiO₂, BaO, ZrO₂, and CeO₂.
